(19) United States
(12) Patent Application Publication
(10) Pub. No.: US 2022/0252284 A1
(43) Pub. Date: Aug. 11, 2022

(54) MULTI-UNIT EVAPORATIVE COOLING SYSTEM FOR STRATIFIED THERMAL AIR CONDITIONING

(71) Applicant: ST Engineering Innosparks Pte Ltd, Singapore (SG)

(72) Inventors: Ee Ho Gareth TANG, Singapore (SG); Fuyun LI, Singapore (SG); Tze Wei Timothy ANG, Singapore (SG); Lok Lee Hillary YAP, Singapore (SG)

(21) Appl. No.: 17/432,254

(22) PCT Filed: Dec. 19, 2019
(86) PCT No.: PCT/SG2019/050626

§ 371 Date: Aug. 19, 2021

(30) Foreign Application Priority Data
Apr. 11, 2019 (SG) PCT/SG2019/050203

(51) Int. Cl. F24F 5/00; F24F 11/77; F24F 1/0059

(52) U.S. Cl. CPC F24F 5/0035; F24F 2120/20; F24F 1/0059; F24F 11/77

(57) ABSTRACT

The invention relates to a multi-unit air conditioning system that conditions ambient air below the wet bulb temperature without the use of a mechanical vapor compression system. The system includes two or more individual units. Each unit can include a heat exchanger and evaporative porous media. By varying output of one or more cooling units and controlling water circulation, the system can condition air to variable temperatures. The system can produce a stratified air flow, whereby layers or pockets of air with discernable dry bulb temperatures and/or humidity remain intact. This can improve efficiency of the system and thermal comfort.

### FIELD OF THE INVENTION

The invention relates to an evaporative cooling system, and more specifically, to an evaporative cooling system with multiple conditioning units for adjusting output, conditioning air with temperature stratification and temperature control.

### BACKGROUND

Conventional air cooling systems or air conditioners (AC's) utilize a complicated array of pipes with a condenser and compressor. A circulating refrigerant such as a chlorofluorocarbon (CFC) is forced into the compressor. Its subsequent release extracts heat from the surrounding air as it expands. These systems consume high levels of energy and can be expensive to own and operate. Efforts have focused on alternative systems that are more environmentally friendly and cost effective.

The temperature of dry air can be lowered by utilizing the phase transition of liquid water to water vapor (i.e. evaporation). Evaporative cooling can be described as the addition of water vapor into air which lowers the temperature of the air. The energy needed to evaporate the water is taken from the air in the form of sensible heat and converted into latent heat while the enthalpy of the air remains constant. This conversion of sensible heat to latent heat is known as an adiabatic process because it occurs at a constant enthalpy. Evaporative cooling causes a drop in the temperature of air proportional to the sensible heat drop and an increase in humidity proportional to the latent heat gain.

Basic evaporative cooling systems, often referred to as “swamp coolers,” use a fan and an evaporative medium. A low pressure, high volume air mover is mounted in a housing that incorporates a large area of porous evaporation pads. Ambient air is circulated through the system where it is cooled and humidified. Because of their simple design, evaporative cooling systems can be more economical than vapor compression systems. However, the air conditioning ability of evaporative cooling systems is limited by the temperature and humidity of the ambient air.

The cooling potential for evaporative cooling is dependent on the wet-bulb depression, the difference between dry-bulb temperature and wet-bulb temperature. Alternatives such as multi-stage evaporative coolers or dew point coolers are designed to overcome this limitation. For example, U.S. patent application Ser. No. 12/185,617 describes an evaporative cooling system that cools air to a temperature below that of the wet bulb temperature. It includes a reservoir of water that is chilled. The cooler water evaporates slower and improves efficiency of the system. A rotating disc sprays chilled water droplets to expose air to a fog-like curtain prior to exiting the chamber.

Similarly, International Patent Application Number PCT/SG2017/050062 describes a system to generate a conditioned supply air with a lower wet bulb temperature than ambient air. The main cooling module includes an indirect evaporative cooling unit for pre-cooling ambient air by reducing sensible heat and a direct evaporative cooling unit for cooling the pre-cooled air through vaporization of water. A heat rejection module includes a second evaporative medium for removing heat in the water thereby producing cool water having a temperature almost equivalent to the intake ambient air wet bulb temperature.

International Patent Application Number PCT/SG2015/050503 describes the configuration, control and operation of a multi-component air-conditioning system. The system includes an environmental sensor, a controlling chip and a plurality of cooling components. The cooling components are activated or inactivated according to a most efficient operating mode. The operating mode is determined based on environmental parameters to yield effective and efficient temperature reduction.

Patent Publication Number WO/2018/021967A1 describes an apparatus with a fluid storage device for holding a volume of coolant, a cooling device with a heat exchanger and a first evaporative media arranged in fluid communication with the fluid storage device. A heat rejection device includes a second evaporative media arranged in fluid communication with the fluid storage device and the heat exchanger. The apparatus can operate in two modes. In the first mode, the first evaporative media is activated to cool the air to a first temperature. In the second mode, the first and second evaporative media and the heat exchanger are collectively activated to cool the air to a temperature lower than the first temperature.

While these inventions present alternatives to conventional air conditioning systems, there is a need for improvement. They are designed to maximize temperature reduction regardless of conditions. The air flow rate can be controlled but the output temperature cannot be adjusted. An improved evaporative cooling system should allow for variable capacity and temperature control. It should also stratify conditioned air when desired by a user for improved efficiency and comfort.

### SUMMARY OF THE INVENTION

The following summary is provided to facilitate an understanding of some of the innovative features unique to the disclosed embodiment and is not intended to be a full description. A full appreciation of the various aspects of the embodiments disclosed herein can be gained by taking into consideration the entire specification, claims, drawings, and abstract as a whole.

Embodiments include a system for stratified air conditioning comprising (a) two or more conditioning units and (b) a heat transfer loop. The conditioning units can each include a heat exchanger and/or an evaporative porous media unit. The heat transfer loop can connect the conditioning units with a series of tubing so that water flows to and between the conditioning units so that the temperature output for each conditioning units can be set relative to another.

Embodiments also include a method of stratified air conditioning comprising steps of (a) providing ambient air to two or more conditioning units, (b) directing water to flow through a heat transfer loop, (c) conditioning the ambient air with a heat exchanger and/or evaporative porous media in the conditioning units, (d) adjusting the output of one of the conditioning units (cold unit) so that the temperature can be controlled and (e) arrangement of the heat transfer loop so that each releases a layer of air with a desired temperature and/or humidity relative to one another to form a stratified flow of conditioned air. The method can include an additional step of cooling water adiabatically in a lower (or adjacent) conditioning unit before returning it to a water reservoir. Each of the conditioning units can be comprised of a sensible heat exchanger, an evaporative porous media unit and a variable-speed fan. A control system can maintain a target air temperature of the cold conditioning unit by controlling fan speed and/or water flow.

Embodiments also include a method for cooling an area with stratified layers of conditioned air comprising steps of (a) providing a system with two or more conditioning units, wherein the two of more conditioning units are each comprised of a heat exchanger and/or an evaporative porous media unit, (b) adjusting water flow through a heat transfer loop that connects the two of more conditioning units with a series of tubing, so that water flows through a heat exchanger and/or an evaporative porous media unit of each of the two or more conditioning units and (c) adjusting output of each conditioning unit by controlling water flow and/or air flow from one or more fans. The two or more conditioning units can independently release conditioned air to form stratified layers.

### INTRODUCTION

A first aspect of the invention is a multi-unit, variable capacity evaporative cooling system with a plurality of conditioning units to cool ambient air.

A second aspect of the invention is a multi-unit, variable capacity evaporative cooling system for producing distinct layers of air of discernible dry-bulb temperature and humidity (i.e. stratified layers), by activating individual conditioning units.

A third aspect of the invention is a multi-unit, variable capacity evaporative cooling system that cools ambient air by sensible heat reduction and adiabatic cooling.

A fourth aspect of the invention is a method of conditioning ambient air that uses a plurality of heat exchange units and evaporative cooling units to adjust air temperature of a single air conditioning unit (cold unit) to a user's preference.

A fifth aspect of the invention is a multi-unit, variable capacity evaporative cooling system that includes a plurality of air stratifying units that operate with a common heat transfer loop.

A sixth aspect of the invention is a method of conditioning ambient air in stratified layers to improve user comfort and/or conditioning efficiency.

A seventh aspect of the invention is a multi-unit, variable capacity evaporative cooling system that operates in different modes (i.e. varies output) by adjusting the flow of water and/or air to the conditioning units.

### BRIEF DESCRIPTION OF THE DRAWINGS

The summary above, as well as the following detailed description of illustrative embodiments, is better understood when read in conjunction with the appended drawings. For the purpose of illustrating the disclosure, exemplary constructions of the disclosure are shown in the drawings. However, the disclosure is not limited to specific methods and instrumentalities disclosed herein. Moreover, those in the art will understand that the drawings are not to scale. Wherever possible, like elements have been indicated by identical numbers.

FIG. 1 is a schematic diagram of a dual-unit air conditioning system with a heat exchanger and two adiabatic coolers to produce stratified conditioned air.

FIG. 2 is a schematic diagram of a dual-unit air conditioning system with a heat exchanger and two adiabatic coolers to produce conditioned air (non-stratified).

FIG. 3 is a schematic diagram of a dual-unit air conditioning system for producing stratified conditioned air.

FIG. 4 is a schematic diagram of an air conditioning system with three conditioning units that depicts heat cascading downward through a heat transfer loop to produce stratified conditioned air.

FIG. 5 is a schematic diagram of an air conditioning system comprised of multiple conditioning units arranged in a vertical configuration to treat air sensibly and adiabatically to produce stratified conditioned air.

FIG. 6 is a schematic diagram of an air conditioning system comprised of multiple conditioning units arranged in a horizontal configuration to produce stratified conditioned air.

FIG. 7 is a flowchart that depicts the steps in a method of producing stratified conditioned air by activating individual sections of a variable capacity evaporative cooling system.

FIG. 8 is a schematic diagram of an air conditioning system comprised of multiple conditioning units operating to produce a cold air steam such that the dry-bulb temperature is approximately equal to the dew point temperature of ambient air.

FIG. 9 is a schematic diagram of an air conditioning system comprised of multiple conditioning units operating to produce a cold air stream without added moisture.

### DETAILED DESCRIPTION OF THE INVENTION

### Definitions

The particular values and configurations discussed in these non-limiting examples can be varied and are cited merely to illustrate at least one embodiment and are not intended to limit the scope thereof. While the invention is described for the conditioning air that is expelled into a room or gathering place, it is understood that the invention is not so limited and can be used to assist with other types of applications that require conditioned air. Other applications include, for example, using the system to condition air for controlled environments. It can condition air and/or remove heat from industrial settings and/or areas with electronic circuits (or other apparatus) that generate heat. The invention can also be scaled down and up for an intended use.

Reference in this specification to “one embodiment/aspect” or “an embodiment/aspect” means that a particular feature, structure, or characteristic described in connection with the embodiment/aspect is included in at least one embodiment/aspect of the disclosure. The use of the phrase “in one embodiment/aspect” or “in another embodiment/aspect” in various places in the specification are not necessarily all referring to the same embodiment/aspect, nor are separate or alternative embodiments/aspects mutually exclusive of other embodiments/aspects. Moreover, various features are described which may be exhibited by some embodiments/aspects and not by others. Similarly, various requirements are described which may be requirements for some embodiments/aspects but not other embodiments/aspects. Embodiment and aspect can be in certain instances be used interchangeably.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. It will be appreciated that the same thing can be said in more than one way.

Consequently, alternative language and synonyms may be used for any one or more of the terms discussed herein. Nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

The term “adiabatic” refers to a process that occurs without transfer of heat or matter between a thermodynamic system and its surroundings. In an adiabatic process, energy is transferred to its surroundings only as work (e.g. vaporization of water).

The term “ambient” refers to a condition of outside air at the location at or near the cooling system.

The term “dew point temperature” refers to the temperature at which air must be cooled to become saturated with water. Air normally contains a certain amount of water vapor. The maximum amount of water vapor that air can hold depends upon the temperature of the air, sometimes referred to as dry bulb temperature (Tab).

The “dry-bulb temperature” refers to the temperature indicated by a thermometer exposed to the air in a place sheltered from radiation and moisture. The term “dry-bulb” is customarily added to temperature to distinguish it from wet-bulb and dew point temperature.

The term “evaporative cooler” or “swamp cooler” refers to a device that cools air through the evaporation of water. The temperature of dry air can be lowered through the phase transition of liquid water to water vapor (evaporation). This can cool air without energy that is necessary for other refrigeration techniques.

The term “evaporative porous media” refers to a material that permits the relatively unobstructed evaporation of water into air. For example, a sheet of cotton fabric can be used to allow water to evaporate into ambient air. Evaporation behavior in layered porous media is affected by thickness and sequence of layering and capillary characteristics of each layer.

The term “heat exchanger” refers to a device used to transfer heat between two or more fluids and/or gases. The fluids can be separated by a solid wall to prevent mixing; or they can be in direct contact with one another. As used herein, temperature change is achieved sensibly with a heat exchanger.

The term “output” refers to the volume (i.e. pressure), humidity and temperature of air expelled from an individual unit. In this regard, output can be adjusted by controlling the flow of air (i.e. fan speed) and the flow of water. For example, maximum output can entail setting the fan to the highest speed along with increasing the water flow. For a lower output, air flow and water flow can be lowered. Alternatively, water flow can be directed to a heat sink without flowing to porous media to avoid adiabatic cooling. In an embodiment, output of each unit is controlled by a user (i.e. the user can adjust the flow of air and flow of water). Alternatively, a processor or control module can control output of each unit based on, for example, user settings and/or ambient temperature and humidity.

The term “sensible” refers to heat exchanged by a body or thermodynamic system in which the exchange of heat changes the temperature of the body or system, and some macroscopic variables of the body or system, but leaves unchanged certain other macroscopic variables of the body or system unchanged, such as volume or pressure.

The term “stratification,” “thermal stratification” or “air stratification” refers to a layering effect that allows layers or pockets of air with discernable dry bulb temperatures and/or humidity to remain intact. Air conditioning efficiency and/or human comfort can be improved by producing stratified layers of air. In contrast, “thermal destratification” refers to the process of mixing air to eliminate stratified layers and achieve temperature equalization throughout an area.

The term “wet-bulb depression” refers to the difference between the dry-bulb temperature and the wet-bulb temperature.

The term “wet bulb temperature” refers to the temperature read by a thermometer covered in water-soaked cloth over which air is passed. At 100% relative humidity, the wet-bulb temperature is equal to the air temperature and is lower at lower humidity. It can be defined as the temperature of a parcel of air cooled to saturation (100% relative humidity) by the evaporation of water into it, with the latent heat supplied by the parcel. The wet-bulb temperature is the lowest temperature that can be reached under current ambient conditions by only the evaporation of water.

### NUMERICAL REFERENCE FEATURES

The following numerical index is provided for ease in cross-referencing between the structural features illustrated in the figures and the accompanying description provided herein.
100—Variable Capacity Evaporative Cooling System (multi-unit)
102—Variable Capacity Evaporative Cooling System (horizontal arrangement)
105—Variable Capacity Evaporative Cooling System (dual unit)
107—Variable Capacity Evaporative Cooling System (alternative design)
108—Variable Capacity Evaporative Cooling System (triple unit)
109—Variable Capacity Evaporative Cooling System (“N” units)
110A—Conditioning Unit (first)
110B—Conditioning Unit (second)
110C—Conditioning Unit (third)
110N—Cooling Unit (subsequent)
130A—Variable Speed Fan (first)
130B—Variable Speed Fan (second)
130C—Variable Speed Fan (third)
130N—Variable Speed Fan (subsequent)
150—Water Reservoir
165A—Evaporative Porous Media Unit (first)
165B—Evaporative Porous Media Unit (second)
165C—Evaporative Porous Media Unit (third)
175—Air Water Heat Exchanger
175A—Air Water Heat Exchanger (first)
175B—Air Water Heat Exchanger (second)
185—Solenoid Valve
195—Water Control Valve
205—Ambient (Intake) Air
210—Conditioned Air
210A—Conditioned Cold Air (upper stratified layer)
210B—Conditioned Cool Air (lower stratified layer)
210C—Conditioned Cold Air (upper non-stratified layer)
210D—Conditioned Cool Air (lower non-stratified layer)
265A—Evaporative Porous Media Unit (first)
265B—Evaporative Porous Media Unit (second)
265C—Evaporative Porous Media Unit (third)
265N—Evaporative Porous Media Unit (subsequent)
275A—Air Water Heat Exchanger (first)
275B—Air Water Heat Exchanger (second)
310A—Conditioned Air (Upper Stratified Layer)
310B—Conditioned Air (Middle Stratified Layer)
310C—Conditioned Air (Lower Stratified Layer)
410A—Conditioned Air (Upper Stratified Layer)
410B—Conditioned Air (Middle Stratified Layer)
410C—Conditioned Air (Lower Stratified Layer)
510A—Conditioned Air (Upper Stratified Layer)
510B—Conditioned Air (Middle Stratified Layer)
510C—Conditioned Air (Lower Stratified Layer)

### DESCRIPTION OF PREFERRED EMBODIMENTS

Embodiments of the invention include a multi-unit, variable capacity evaporative cooling system for conditioning ambient air. The system can be packaged as a stand-alone unit with an air intake to draw in ambient air and one or more return ducts to expel conditioned air. The system can also include components that are common in the art to monitor and control air flow and temperatures such as sensors, circuits, fans, valves, pipes, filters and a user interface.

The system can use two air conditioning mechanisms. The first is a heat exchanger that uses sensible heat reduction. Sensible air conditioning occurs as heat is transferred between water and the ambient air. The heat exchanger can include a series of pipes or tubes to increase its surface area with the air. Ambient air contacts the surface of the heat exchanger which has a lower temperature. The temperature difference between the warm ambient air and the heat exchanger results in the transfer of heat. Consequently, ambient air that enters the evaporative cooling unit is cooled sensibly to a lower temperature without increasing its humidity.

The second conditioning mechanism uses evaporative porous media for an adiabatic cooling process. Water flows through the evaporative porous media and cools the air adiabatically through the vaporization of water. The entering air passes across the wet surface of the evaporative medium. Adiabatic cooling results as surface water evaporates. Thus, the temperature of the passing air is reduced through an increase in its humidity. The combination of these sensible and adiabatic cooling can produce conditioned air of a lower temperature than the pre-treatment wet bulb temperature.

An additional benefit obtained as water flows through the evaporative porous media is the lowering of the water temperature through evaporative cooling. Just as heat is removed from air to vaporize water, heat is also simultaneously removed from the unvaporized water in the evaporative medium. The resulting unvaporized water will therefore experience a drop in temperature. The longer the same body of water is pushed through an evaporative cooling process, the lower the water temperature becomes. However, the temperature drop is still limited to the wet bulb temperature of the air that is passed over the water surface. More specifically when referencing to the cooling of water in an evaporative medium, the temperature of the water during the earlier stages in the evaporative medium will be the highest, with the temperature gradually reaching the wet bulb temperature limit as it continues to flow through the evaporative medium before exiting.

The continuous cooling of the water in the evaporative medium gives rise to a further benefit of cooling the air passing over the water surface sensibly. While the relative humidity of the passing air determines the amount of adiabatic cooling by water that is possible, the absolute temperature gradient between the passing air and water determined the amount of sensible cooling possible. The larger the temperature gradient between the air and water temperature, the greater the amount of sensible cooling provided by the cooler water. It is therefore advantageous that the temperature difference between air and water is large to induce additional cooling that is not possible adiabatically.

Conventional swamp coolers typically use a single evaporative porous media unit to lower the temperature of ambient air. A fan drives air through the cooler to produce a single stream of conditioned air. The temperature of output air cannot be adjusted as output is usually limited to adjusting fan speed. In contrast, the present invention uses multiple conditioning units. Each conditioning unit can include evaporative porous media and a heat exchanger. Each conditioning unit can also include components such as a fan, temperature/humidity sensor, user controls, etc. Through the coordinated action of the individual units, the system can produce multiple air streams of varying temperatures (i.e. stratified layers of conditioned air). A user can also adjust output temperature and humidity of a single section (cold unit) of air, and the capacity of the cooling.

The system can include multiple distinct conditioning units. Each conditioning unit can cool ambient air sensibly and/or adiabatically. The units can be arranged horizontally, vertically or otherwise adjacent with one another to for the cooling system. A heat transfer loop provides a system of tubes that circulate water for the two mechanisms and includes pipes/tubing, pumps, valves and/or sensors. A control system can include a processer with the logic operation for the system and a series of input conditions and output requirements.

The invention recognizes the benefits of stratified air flow. Conventional conditioning systems are focused on achieving a uniform temperature and humidity in an area. Embodiments of the invention include a system and method of expelling stratified layers of air toward a user. For example, conditioned (i.e. chilled) air can be directed to the location in a room where a person is more likely to be present of sit for extended periods of time. Further, the air can be directed to the torso of the user. Conditioned air will likely have a greater effect when strategically directed in this manner. By utilizing multiple air conditioning units arranged vertically or adjacent to one another, conditioned air can be produced in layers. Each layer (i.e. stratification) can have a discernable temperature and/or humidity. The layer with the most desirable temperature and humidity can be directed to a region or area where it will have the greatest effect. Further, the layer that is adjustable can be directed to a main region of interest so that adjustments can be made to provide thermal comfort according to specific individual needs. This can improve the air conditioning efficiency as well as human comfort.

### Multi-Component Evaporative Cooling System

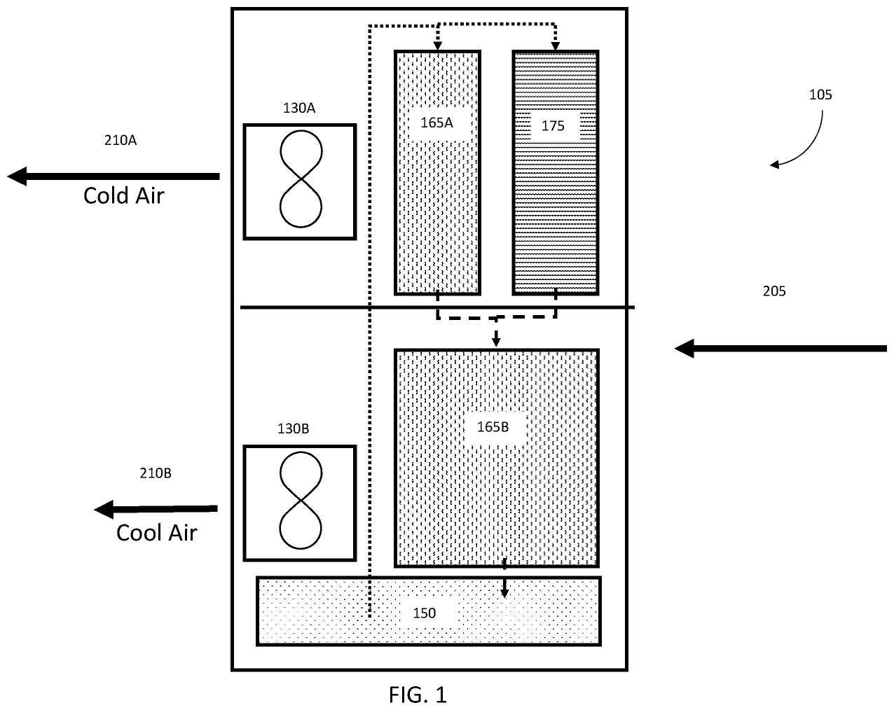

FIG. 1 depicts a basic two conditioning unit variable capacity evaporative cooling system 105 in a vertical arrangement. Ambient air flows into the conditioning units where it is treated. Each conditioning unit can include an air-water heat exchanger and/or evaporative porous media. A variable-speed supply fan and/or exhaust fan (130A, 130B, 130N) creates a pressure difference to drive air through each conditioning unit and out of system ducts. Solid arrows show the direction of the airflow into and out of the system. Dotted arrows show the flow of water through the heat transfer loop to each conditioning unit. Dashed arrows show the flow of water through each conditioning unit and back to the water reservoir 150.

The upper unit includes evaporative porous media 165A and an air-water heat exchanger 175 for adiabatic and sensible conditioning respectively. The upper unit expels “cold” air 210A. A lower unit uses a second evaporative porous media unit 165B for adiabatic conditioning. The main purpose of the lower unit is to reduce the temperature of water flowing to the water reservoir 150 to the wet-bulb temperature of the ambient air. However, the lower unit also expels “cool” air 210B (i.e. conditioned air). The temperature of the cool air 210B is lower than that of the ambient air but higher than that of cold air expelled by the upper unit 210A.

The water reservoir 150 supplies water to the components of each unit through the heat transfer loop. The water is directed to the upper unit and then flows down to the lower unit. Ambient air 205 flows into the system where it is cooled by the water (sensibly and/or adiabatically) and conditioned air is expelled (210A, 210B).

The system expels two distinct layers (i.e. a stratification) of air (210A, 210B). An upper layer of cold, less humid air 210A is distinct from a lower layer of cool, more humid air 210B. Both layers are at a lower temperature than that of the ambient air 205. For example, at ambient conditions of 32° C. and 60% relative humidity, the dry-bulb temperature of the stream of cold air 210A is approximately 25° C. The temperature of the cool air 210B is usually between 28° C. to 29° C. In a preferred embodiment, the upper layer is directed to a level most likely to provide thermal comfort to one or more users. This is typically at or above the level of one's torso. The lower layer is directed below the torso level and may be less noticeable to users.

The lower unit can be used mainly to reduce the temperature of the flowing water. Thus, the heat load from the top unit is shifted to the bottom unit to improve thermal comfort. This shift of heat load therefore occurs in a “cascading” manner. Compared to the top section, the bottom section produces a layer of air with higher dry-bulb temperature. However, the lower unit is also effective in conditioning air as expelled air has a lower temperature than that of the ambient air.

The core components (i.e. evaporative porous media 165A, 165B and air-water heat exchanger 175) can be arranged in different configurations and combinations. Further, the water flow to the conditioning units can also be adjusted which allows the system to adjust for variable thermal loads. In this regard, the heat transfer loop can include pumps, valves and/or sensors to control the flow of water through a water circuit.

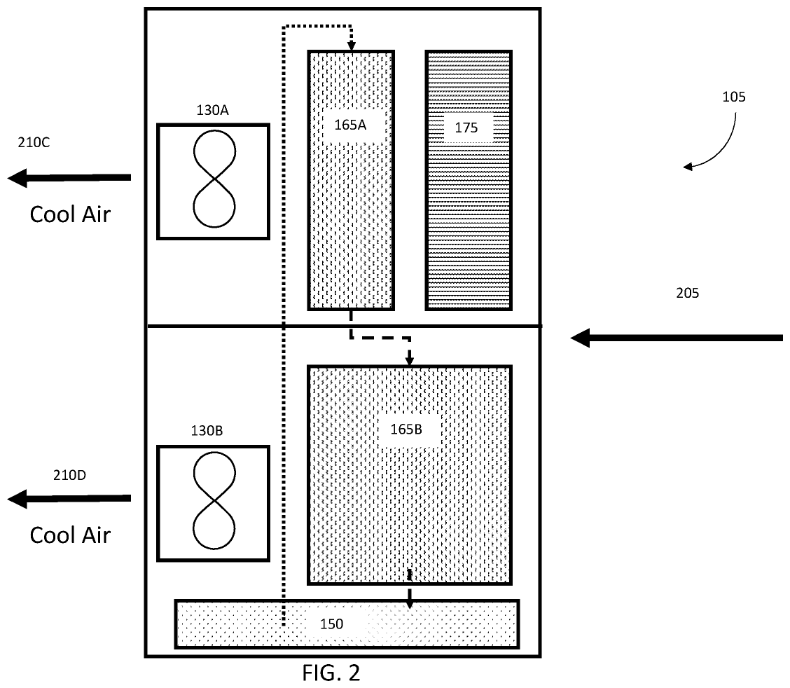

FIG. 2 depicts an alternative mode of operation of the variable capacity evaporative cooling system from FIG. 1. In this mode, the system operates similar to a conventional evaporative cooler. The heat transfer loop directs water to the evaporative porous media units (165A, 165B) and then returns it to the reservoir 150. Here, the circulating water is not directed to the air-water heat exchanger 175 for sensible conditioning. Air that enters the cooling units passes through the evaporative porous media units (165A, 165B) and is directed out of the system as “cool” conditioned air (210C, 210D). The sensible cooling component 175 remains inactive and there is no stratification of air between the upper and lower sections. This mode of operation demonstrates how output of the system can be adjusted based on ambient conditions and/or user preferences. Individual components within each unit can be operated independently to control the quality of the output air. As discussed, conventional evaporative coolers typically lack control of the level of which ambient air is conditioned.

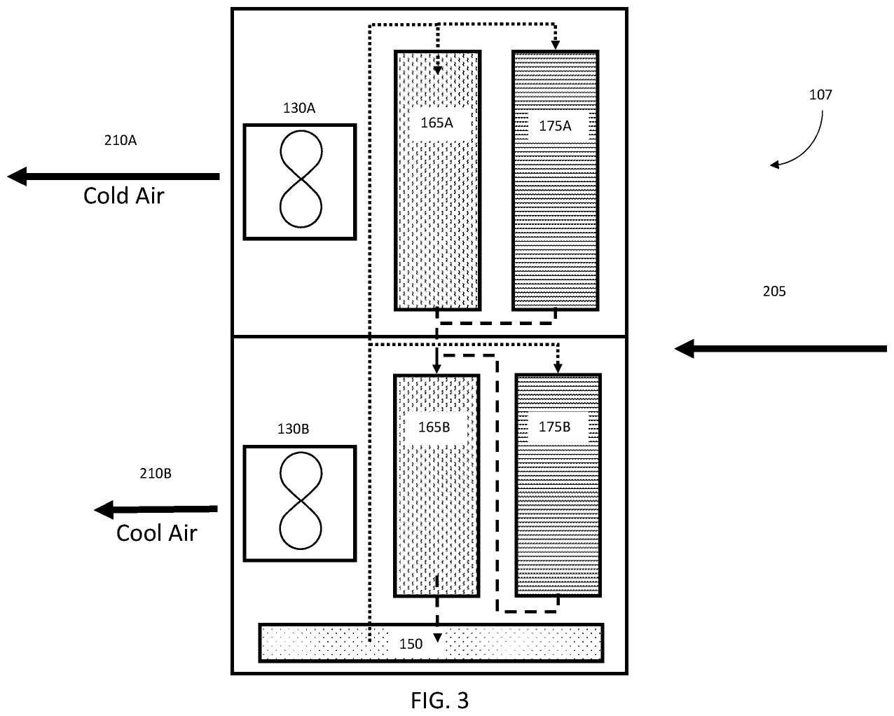

FIG. 3 depicts an alternative design of a variable capacity evaporative cooling system 107. An upper unit includes evaporative porous media 165A and an air-water heat exchanger 175A. A lower unit also uses evaporative porous media 165B and an air-water heat exchanger 175B. Air can be conditioned sensibly and adiabatically in both the upper unit and the lower unit.

As in the previous examples, the flow of water from the water reservoir 150 is depicted with dotted arrows. The water is directed to the evaporative porous media 165A and the air-water heat exchanger 175A of the upper unit and the air-water heat exchanger 175B of the lower unit. It then flows down to components of the lower unit where it is directed to the evaporative porous media 165B to reduce the temperature of the water before returning it to the water reservoir 150.

The cooling capacity of the top unit is increased by evaporative porous media in the bottom unit 165B, which cools the water before it enters the water reservoir 150. This process enhances the effect of air stratification as there is a greater reduction in the dry-bulb temperature of the cold air produced by the top section.

Variations of the physical dimensions of the heat exchangers are also possible and can be integrated in a similar manner. For example, the size of the heat exchanger and area of the evaporative porous media can increase the cooling capacity. Further, the airflow volume can be varied according to user preferences. This demonstrates the versatility of the system. Many options are possible based on the arrangement of the core cooling components and the manner that water is pumped through the system.

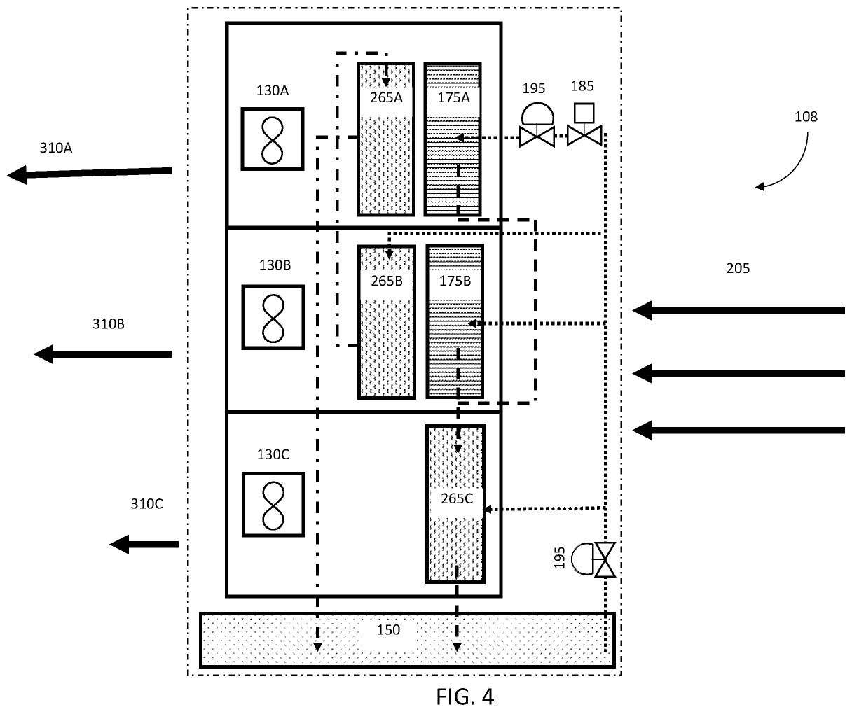

FIG. 4 depicts an alternative design of a variable capacity evaporative cooling system with three conditioning units 108 arranged in a vertical manner. An upper unit designated as the cold unit includes evaporative porous media 265A, an air-water heat exchanger 175A, an electronic solenoid valve 185 and an electronic water control valve 195. A middle unit includes evaporative porous media 265B, an air-water heat exchanger 175B. A lower unit includes evaporative porous media 265C. In both the upper (cold unit) and middle units, air is conditioned sensibly and adiabatically. In the lower unit, air is conditioned adiabatically. A water reservoir 150 supplies water to the components of each unit via the heat transfer loop (dotted arrows).

This configuration demonstrates how stratified air (i.e. multiple air streams of distinct quality) can be produced by the system by utilizing a downward cascade of heat energy and the continuous cooling of water in the evaporative porous media. The water is directed from the reservoir 150 to the air-water heat exchanger of the upper and middle units (175A, 175B) and the middle and lower evaporative porous media units (265B, 265C). The water flowing through the middle evaporative porous media 265B is directed to the upper evaporative porous media (cold unit) 265A. The water from the upper evaporative porous media 265A can then be channeled to either pass through the lower evaporative porous media 265C or flow directly back into the water reservoir 150.

The system expels three distinct layers (i.e. a stratification) of air (310A, 310B, 310C). An upper layer of cold, less humid air 310A is distinct from middle and lower layers of cool, more humid air (310B, 310C). However, all three layers are at a lower temperature than the ambient air 205. For example, at ambient conditions of 32° C. and 60% relative humidity, the dry-bulb temperature of the upper layer 310A produced will be approximately 24° C. The temperature of the middle layer 310B will be between 26° C. to 27° C. As described in the previous example, the main purpose of the lower unit is to reduce the temperature of the flowing water. Nevertheless, the dry-bulb temperature of the lower layer 310C will be between 28° C. to 29° C., at the same ambient conditions.

### Heat Transfer Loop System

The system uses circulating water for the air-water heat exchanger(s) and the evaporative porous media unit(s). The heat transfer loop system can include elemental units for water flow circulation and regulation, such as pumps and valves. A supply of water can be stored in a water reservoir 150. Water from the reservoir can be pumped through the air-water heat exchanger and evaporative porous media.

As depicted in FIG. 3 and FIG. 4, water from the reservoir 150 can be pumped into multiple conditioning units and returned to the reservoir after is passes through the lower unit. In one embodiment, the water enters an air-water heat exchanger where it cools circulating air. Thereafter, the water enters an evaporative porous media unit. The evaporation of a portion of the water provides the adiabatic cooling to both the circulating air and water. In another embodiment, water flow is pumped from the reservoir 150 directly to evaporative porous media. Yet in another embodiment, water flow is pumped from one evaporative porous media to another evaporative porous media.

As described, the system can include upper, middle and lower conditioning units as depicted in FIG. 4. The flow of water can be controlled with a pump (not shown), an electronic solenoid valve 185 and/or an electronic water control valve 195. In this example, water is directed from the reservoir 150 to both air-water heat exchangers (175A, 175B) and the evaporative porous media units of the middle and lower unit (265B, 265C).

In a preferred embodiment, the lower unit is mainly used to reduce the temperature of the flowing water before returning it to the water reservoir 105. The water flowing through the middle evaporative porous media 265B exits at a lower temperature compared to what it was supplied, and is therefore directed to the upper evaporative porous media (cold unit) 265A to enhance the cooling by the upper conditioning unit even more through the combined effect of adiabatic and sensible cooling by a colder water source. This shifts the heat load from the top unit and the middle unit toward the bottom unit (i.e. in a cascading manner). The bottom unit conditions air to a temperature lower than that of the ambient air. However, it is at a higher temperature than conditioned air from the middle and upper units, with the upper unit producing the lowest air temperature. This configuration can optimize efficiency of the system and improve thermal comfort.

### Operating Modes

The efforts of the air conditioning units can be varied according to a most efficient operating mode or conditioning requirements. Each unit can include a variable speed fan (130A, 130B, 130N) to allow adjustment of air flow. As described above, output can also be controlled by adjusting the amount of water flowing to the conditioning units through a flow valve. Further, water flow to the cold unit, which is the conditioning unit designated to target the user heat zones, i.e. torso region, can be adjusted with an electronic solenoid valve and/or an electronic water control valve to provide enhanced temperature control for thermal comfort without much affecting spatial cooling provided by the other conditioning units.

### Multi-Unit Evaporative Cooling System

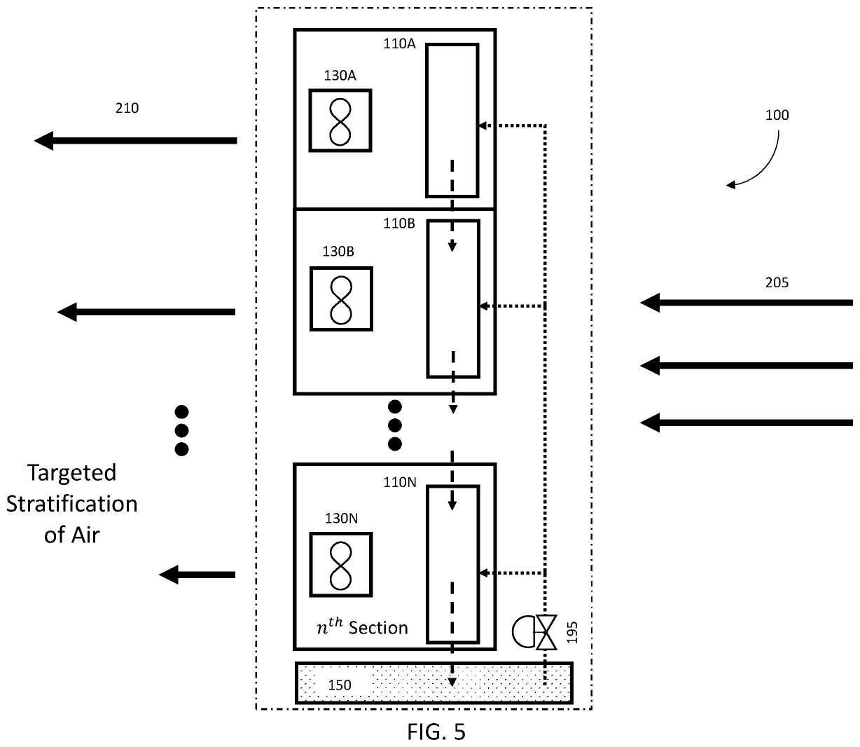

FIG. 5 depicts an alternative design of a variable capacity evaporative cooling system 100 with multiple conditioning units with cooling components (110A, 110B, 110N). Ambient air flows into the conditioning units where it is treated. While three conditioning units are depicted, the system can have any number of units for an intended use. For the sake of illustration, the system is depicted with “n” sections. Each conditioning unit can include an air-water heat exchanger and/or evaporative porous media. A variable-speed supply fan and/or exhaust fan (130A, 130B, 130N) creates a pressure difference to drive air through each conditioning unit and out of system ducts.

Solid arrows show the direction of the airflow into and out of the system. Dotted arrows show the flow of water through the heat transfer loop to each conditioning unit. Dashed arrows show the flow of heat through each conditioning unit 150. The ambient air 205 enters the conditioning units, passes through an air-water heat exchange and/or through evaporative porous media before it is directed out of the system ducts as conditioned air 210. The coldest layer of air (cold unit) can be directed to a level such as the torso region of an occupant in a room.

In this particular example, water circulates from a water reservoir 150 to each of the conditioning unit. The first conditioning unit 110A is designated to be the cold unit. The water loop between each conditioning unit is configured such that the heat from one conditioning unit is transferred to the next conditioning unit, until it is channeled to the final unit 110N, designated to reduce the water temperature (remove the heat) before flowing back to the water reservoir 150. In this regard, heat flows downward from one conditioning unit to the next, from the first conditioning unit 110A. The system uses the water to drive heat downward through the system in a “cascading” manner.

Ambient air 205 flows into the system where it is conditioned and expelled 210. The “stratified” output flow of air is therefore created by the configuration of the water flow loop between each conditioning unit. The level of cooling for the system can be adjusted through the throttling of water flow with the use of a control valve. The temperature and humidity output from the cold unit can also be adjusted with the solenoid valve and flow control valve. As depicted by the horizontal arrows, air is conditioned to different levels along a series of ducts. The length of the arrow represents the degree that it is cooled (i.e. a longer arrow depicts colder air). Each unit can produce a stream of air (i.e. layer of stratified air) of a particular temperature and or humidity. In this example, the thermal comfort for a user is improved with highest output at air streams along central ducts of the system.

Variable-speed supply fans and/or exhaust fans (130A, 130B, 130N) drive ambient air through the system. The conditioned air can be directed toward one or more users. In one embodiment, conditioned air is directed into a room or area inside a structure. The system can also treat air in an outdoor environment, in which case, conditioned air is directed toward one or more individuals in a gathering area.

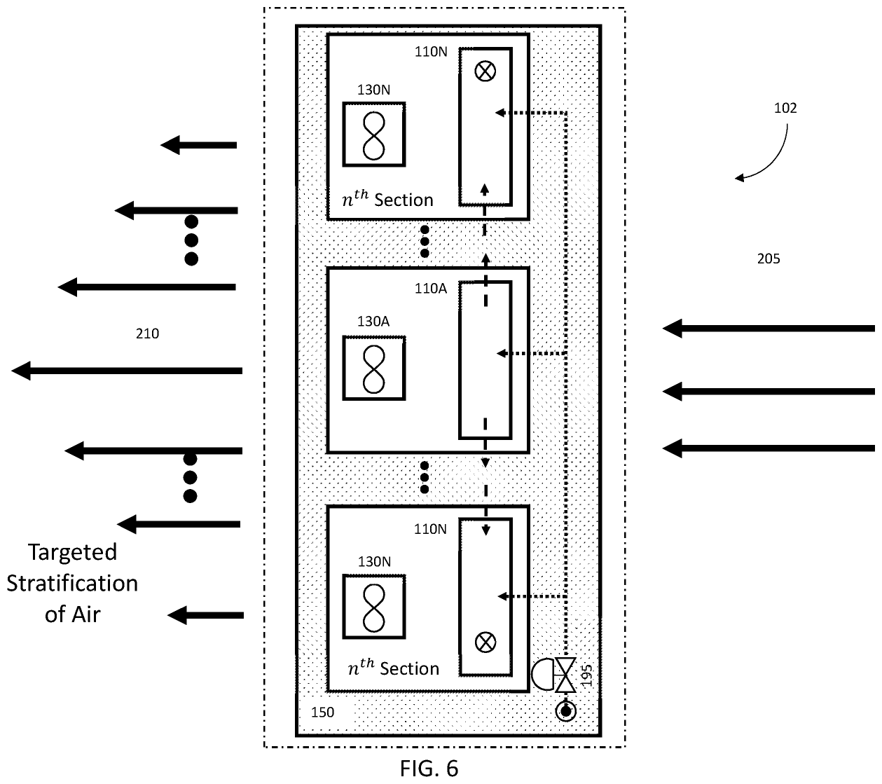

While the conditioning units are arranged vertically upon one another in FIG. 5, the units can also be arranged horizontally with respect on one another. FIG. 6 depicts the top-view of a system architecture in which the conditioning units are arranged horizontally 102. When arranged horizontally, water can flow from one unit to one or more adjacent units. The system can produce stratified layers of conditioned are that are adjacent to one another horizontally. This arrangement can produce stratified conditioned air with the coldest layer directed to an area where an occupant is most likely to be present such as a sitting area in the center of a room.

In the horizontal configuration, heat flow sideways from one conditioning unit to adjacent units. FIG. 6 depicts the top view of a horizontal arrangement of conditioning units with the water reservoir 150 below the conditioning units. The system operates in a similar manner to the vertical configuration described above. Heat flows from the first conditioning unit (cold unit) 110A to adjacent units, until it reaches the unit designated to reduce the water temperature 110N. The cold unit is this time positioned in the central portion of the system with the other conditioning units flanking it, The conditioned air from the flanking units can be directed to areas where occupants are unlikely to be present (e.g. around the circumference of a room).

While FIG. 5 and FIG. 6 depict two possible position of the cold unit, and the conditioning unit designated to reduce the water temperature at the corner, it is possible that the cold unit be positioned at any position along the system that will best reach the highest heat zones. Similarly, the unit designated to reduce the water temperature can also be positioned anywhere along the system.

### Control System

A control system contains the logic operation of the system and a series of input conditions and output requirements. The control system can include a control algorithm and input/output devices to operate the evaporative cooling system. The control system can operate the cooling system and target a comfortable apparent temperature level at user selected values by using the most energy efficient operation mode.

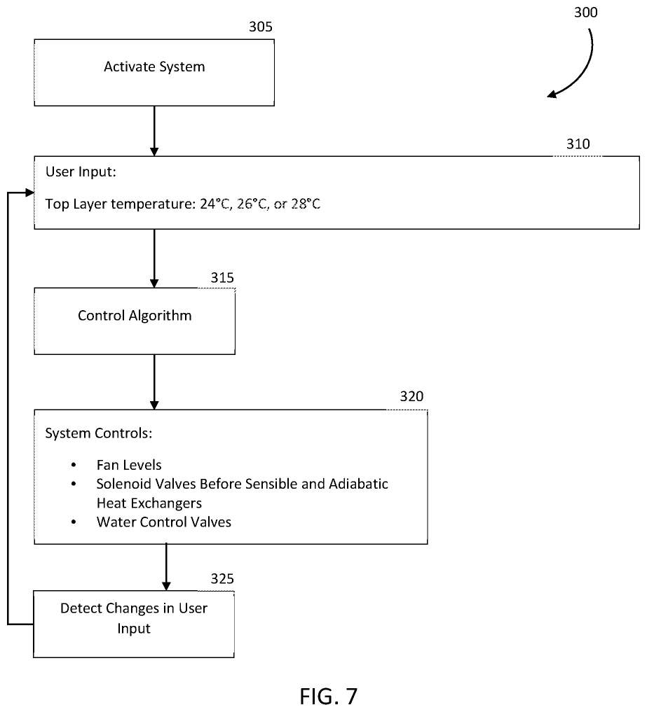

FIG. 7 depicts a series of steps 300 involved in operating the variable capacity evaporative cooling system and its control system. A user can activate the system 305 and enter preferred criteria through a user interface 310 for the desired dry-bulb temperature of the stratified output, which is achieved by the control of water flow in the heat transfer loop and the selective activation or deactivation of components in the cold unit. Specifically, the user can choose a target temperature of 24° C., 26° C. or 28° C. for the cold unit.

Based on the control algorithm 315, capacity is adjusted by adjusting water and/or air flow. The system also includes control components 320 to control fan levels and electronic valves. Further, the system can control the desired dry-bulb temperature of the cold unit based on user input. Thereafter, the user can change the settings 325 if desired. Output of individual units can be controlled based on user input and/or ambient conditions to produce stratified air flow.

### Working Example

### Use of the System to Produce Stratified Conditioned Air in a Room or Structure

The evaporative cooling system can be used to condition air inside a residence. In this example, a user enters desired criteria such as a target temperature into the system. Sensors monitor conditions inside the residence and adjust the system controls.

The user activates the system through a switch or user interface. With reference to FIGS. 4 and 7, depending on the user's input, the amount of water flowing through the heat transfer loop to the conditioning units can be adjusted to control the capacity of the stratified cooling. At each conditioning unit, a variable-speed fan (130A, 130B, 130C) drives ambient air through the system. Subject to the user's input on the desired temperature output of the cold section, the ambient air enters the cold unit can be first cooled with a sensible heat exchanger (275A) that does not increase the humidity. The next stage can include an evaporative cooling process whereby sensible heat is converted to latent heat through the vaporization of water at the evaporative porous media unit (265A). A solenoid valve 185 can control the activation and deactivation of the sensible heat exchanger 275A and the electronic control valve 195 controls the rate of water flowing into the sensible heat exchanger 275A.

Stratified layers of air (310A, 310B, 310C) each of distinct dry-bulb temperature and humidity are directed out of the system into the room or gathering area. The evaporative cooling also chills water that circulates through the system. Chilling is enhanced by directing the flow of water exiting one evaporative porous media unit to the next evaporative porous media unit, with the final evaporative porous media unit being the cold unit, before directing the water back to the water reservoir 150. The combination of these conditioning stages provides for outlet supply temperatures to go below the pre-treatment wet bulb temperature without the use of a mechanical vapor compression system. The multi-unit design allows for layers or stratifications of air. The coolest air can be directed at the core or torso of the user or in a desired direction with the use of louvers. Streams of air from the lower unit can be directed at users who prefer cool air, or in situations where the ambient dry-bulb temperature is low, such as during rainy weather.

### User Selection of Operating Mode

Referring to FIG. 4, after activating the system, the user can be prompted to select the desired output temperature of the cold unit. For example, the user can select one of the three dry-bulb temperatures: 24° C., 26° C. or 28° C.

With a desired output of 24° C., the system operates to maximize cooling capacity. The solenoid valve 185 is open. Water flow through the heat transfer loop is set to the maximum and flows through both heat exchangers (275A, 275B) and the evaporative porous media units (265A, 265B, 265C).

With a desired output of 26° C., water flow through the heat transfer loop is set to maximum and flows through both heat exchangers (275A, 275B) and the evaporative porous media units (265A, 265B, 265C). However, the control valve 195 is adjusted to regulate the volume of water flow. The rate of water flow into the heat exchanger is approximately half of capacity.

With a desired output of 28° C., the water flow through the heat transfer loop is set to a predetermined flow rate that is enough to sufficiently wet the evaporative porous media units. The solenoid valve 185 is closed. The system functions like a single-stage evaporative cooler, and produces a single air stream at a dry-bulb temperature of 28° C.

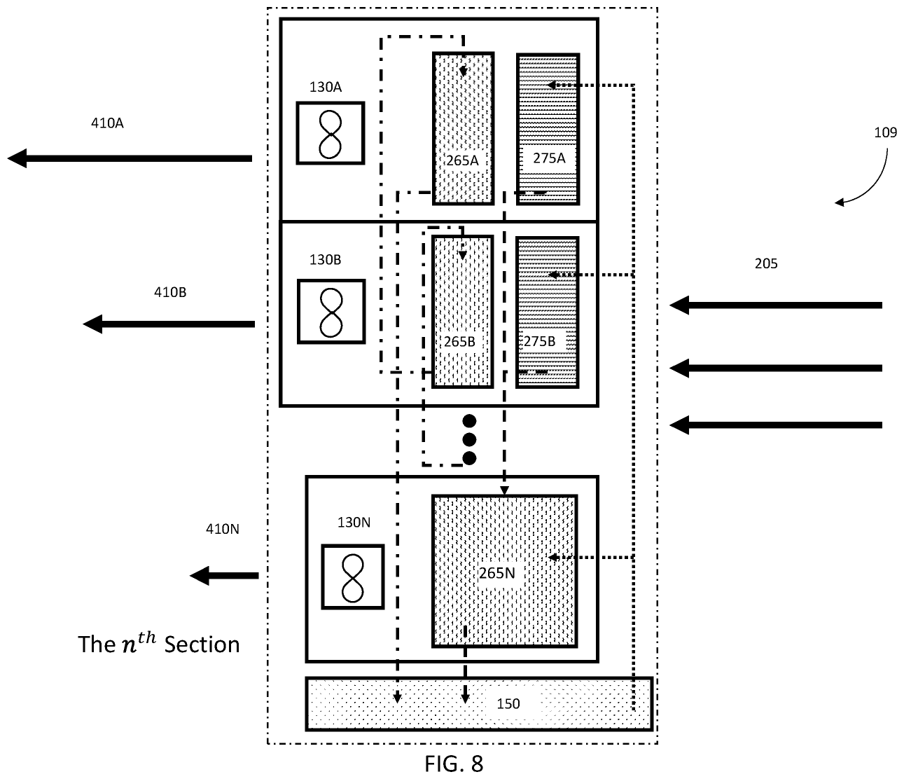

FIG. 8 depicts a mode of operation in which the system performance and thermal comfort is maximized. Here, the dry-bulb temperature of the stratified layer 410A released from the top section (cold unit) is approximately equal to the dew point temperature of the ambient air. Under ambient conditions of 32° C. and a relative humidity of 60%, the dry-bulb temperature of the top stratified layer of air 410A will be approximately at 23° C., while the temperature of the air produced from the bottom section will be approximately 28° C. In this configuration, the heat is cascaded down through the individual units, thus achieving the coldest air at the top section that is at approximately the dew point temperature of the ambient air 205.

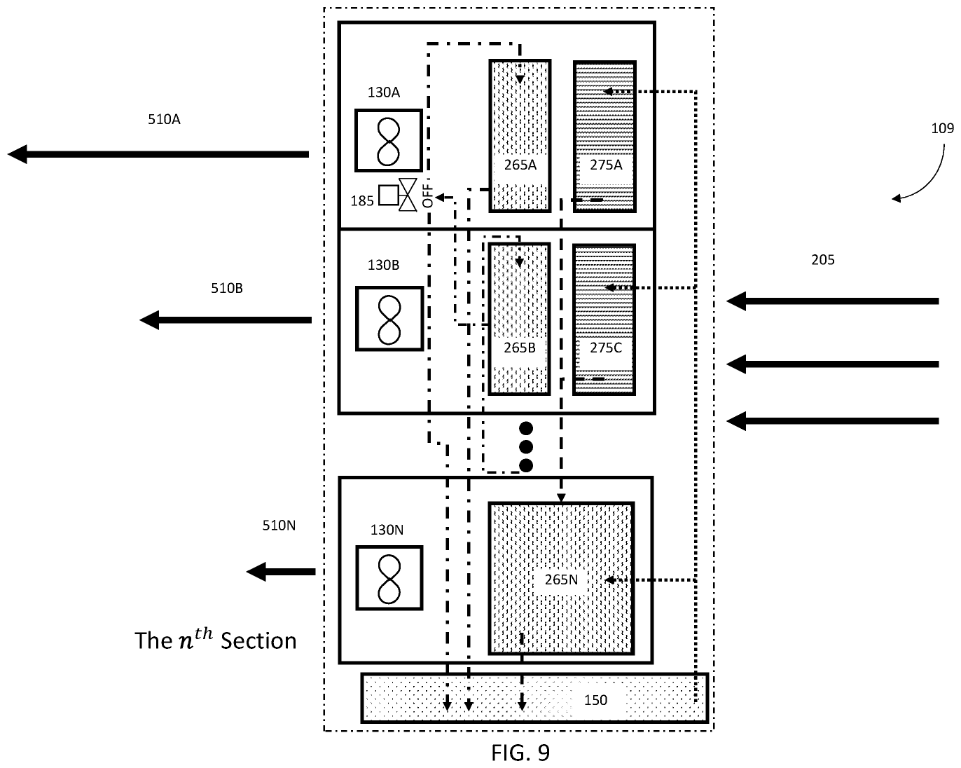

FIG. 9 depicts a setting in which the system is configured to produce a stratified layer of air 510 from the top section, without the addition of moisture. The solenoid valve 185 is shut so that water bypasses the evaporative porous media unit 265A. In this configuration, the multi-section embodiment can lower the temperature of the water returning to the reservoir 150 to approximately the dew point temperature of the ambient air 205. This produces the lowest possible dry-bulb temperature for the air stream released from the top section, without the addition of moisture. Under ambient conditions of 32° C. and a relative humidity of 60%, the dry-bulb temperature of the top-most stratified layer of air 510 will be approximately 24° C., while the temperature of the air produced from the bottom section will be approximately 28° C.

It will be appreciated that variations of the above disclosed and other features and functions, or alternatives thereof, may be combined into other systems or applications. Also, various unforeseen or unanticipated alternatives, modifications, variations or improvements therein may be subsequently made by those skilled in the art which are also intended to be encompassed by the following claims.

Although embodiments of the current disclosure have been described comprehensively, in considerable detail to cover the possible aspects, those skilled in the art would recognize that other versions of the disclosure are also possible.

1. A system for stratified air conditioning comprising:
a. two or more conditioning units; and
b. a heat transfer loop;
wherein each of the two of more conditioning units comprise an evaporative porous media unit, wherein at least one of the two of more conditioning units comprises a heat exchanger;
wherein the heat transfer loop connects the two of more conditioning units with a series of tubing so that water flows from an evaporative porous media unit of one conditioning unit to an evaporative porous media unit of one or more additional conditioning units;
wherein output of each conditioning unit can be adjusted; and
wherein the two or more conditioning units independently release conditioned air to form stratified layers directed towards a user.

2. The system for stratified air conditioning of claim 1, wherein the heat transfer loop is comprised of one or more pumps, a water reservoir and one or more valves.

3. The system for stratified air conditioning of claim 1, wherein the two or more conditioning units are further comprised of one or more variable speed fans.

4. The system for stratified air conditioning of claim 1, wherein the two or more conditioning units are arranged vertically upon one another to form a single system.

5. The system for stratified air conditioning of claim 1, wherein the two or more conditioning units are arranged horizontally with respect to one another to form a single system.

6. The system for stratified air conditioning of claim 1, wherein a conditioning unit cools circulating water adiabatically before returning the circulating water to a reservoir.

7. The system of claim 1,
wherein each of the two or more conditioning unit releases conditioned air based on user input.

8. (canceled)

9. (canceled)

10. (canceled)

11. (canceled)

12. The system for stratified air conditioning of claim 7, wherein each of the two or more conditioning units releases a conditioned layer of air based on user input.

13. A method of stratified air conditioning comprising steps of:
a. providing ambient air to two or more conditioning units, wherein each of the two of more conditioning units comprises an evaporative porous media unit, wherein at least one of the two of more conditioning units comprises a heat exchanger;
b. directing water flow to the two or more conditioning units through a heat transfer loop, wherein the heat transfer loop directs the flow of water from an evaporative porous media unit of a first conditioning unit to an evaporative porous media unit of one or more additional conditioning units;
c. conditioning the ambient air with a heat exchanger and/or evaporative porous media in each of the two or more conditioning units; and
d. adjusting the water flow and/or air flow to the conditioning units so that each releases a layer of air that is directed towards a user and is based on the user input to form a stratified flow of conditioned air.

14. The method of stratified air conditioning of claim 13, wherein each of the two or more conditioning units is comprised of a sensible heat exchanger, an evaporative porous media unit and a variable-speed fan.

15. The method of stratified air conditioning of claim 13, wherein the heat transfer loop is comprised of one or more pumps, water flow control valves, a water reservoir and pipes that connect the conditioning units.

16. The method of stratified air conditioning of claim 13, including an additional step of directing water flow expelled from an evaporative porous media from a first conditioning unit toward an evaporative porous media of a second conditioning unit.

17. The method of stratified air conditioning of claim 13, including an additional step of cooling water expelled from one or more heat exchangers adiabatically in a designated conditioning unit before returning it to a water reservoir.

18. The method of stratified air conditioning of claim 13, wherein a control module adjusts water flow through the heat transfer loop and/or air flow through each of the two or more conditioning units.

19. The method of stratified air conditioning of claim 13, wherein the two or more conditioning units are arranged horizontally with one another to form a single system.

20. The method of stratified air conditioning of claim 13, wherein the two or more conditioning units are arranged vertically with one another to form a single system.

21. (canceled)

22. A method for cooling an area with stratified layers of conditioned air comprising steps of:
providing a system with two or more conditioning units, wherein each of the two of more conditioning units comprises an evaporative porous media unit, wherein at least one of the two of more conditioning units comprises a heat exchanger;
adjusting water flow through a heat transfer loop that connects the two or more conditioning units with a series of tubing, so that water flows from an evaporative porous media unit of one conditioning unit to an evaporative porous media unit of one or more additional conditioning units,
adjusting output of each conditioning unit by controlling water flow and/or air flow from one or more fans;
wherein the two or more conditioning units independently release conditioned air to form stratified layers that is directed towards a user.
